(19) United States
(12) Patent Application Publication
(10) Pub. No.: US 2005/0220964 A1
(43) Pub. Date: Oct. 6, 2005

(54) Process for preparing low-calorie drinks and the low-calorie beverages resulting therefrom

(76) Inventors: Noe Rizo, Irapuato (MX); David Reische, Fort Worth, TX (US); Sandrine Dehove, Newport Beach, CA (US); Duc Nguyen, Fort Worth, TX (US)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/817,847

(22) Filed: Apr. 6, 2004

(51) Int. Cl. A23C 17/00

(52) U.S. Cl. 426/583; 426/590

(57) ABSTRACT

A process for producing a low-calorie or low-fat dairy beverage comprising static inline mixing of yogurt, especially non-fat yogurt, water, and a fruit preparation. This process takes advantage of the naturally acidic nature and enzymatic properties of yogurt and specific mixing steps which minimize sheer and stress on the product in order to produce a fruit-dairy beverage having a suitable pH, viscosity, and other organoleptic properties. A low calorie and low fat dairy beverage produced by this process.

### BACKGROUND OF THE INVENTION

1. Field of the Invention

The present invention relates to a process for producing dairy-based beverages, especially to the formulation of a light and refreshing beverage produced with yogurt and fruit which is lower in fat than comparable drinks, has probiotic properties, and is easily drinkable.

2. Background Art

Dairy beverages, such as milk, buttermilk and kefir, have been known since ancient times. Today, consumers want dairy products which not only are more tasty, fin and convenient, but which integrate into a wellness plan, such as a health conscious diet or weight loss regimen.

Milk-based beverages are perceived by many consumers as being heavy, high in fat and unsuitable for consumption during physical activity, such as during sports. Similarly, milk-based beverages sometimes suffer from the perception that they are not as refreshing as light, fruity beverages. On the other hand, light fruity beverages do not provide the nutrients that milk products do and fermented milk products can have probiotic benefits not provided by light fruity drinks, such as providing high levels of live and active lactobacilli.

Conventional means for combining fruit and milk or dairy based beverages suffer from various problems and obstacles. For instance, the acidity of fruit preparations is incompatible with many milk and dairy based beverages, resulting in curdled, organoleptically unacceptable blends. Dynamic blending of fruit and milk beverages can also result in unacceptable sheer and stress causing a loss of desirable natural properties of both the fruit and milk components of a beverage, including the loss of product viscosity and a loss of viability of live microorganisms contained in fermented milk products.

Moreover, dynamic blending imposes additional costs on a commercial or industrial scale process. For example, it requires energy input for operation of the dynamic blender and adds complexity to the production process.

The present invention sets forth a process which avoids these problems and produces an organoleptically superior product resulting from the combination of fruit and milk or other dairy products. This process takes advantage of the naturally acidic nature and enzymatic properties of yogurt, and specific mixing steps which minimize sheer and stress on the product in order to produce a fruit-dairy beverage having a suitable pH, viscosity, and other organoleptic properties.

### BRIEF SUMMARY OF THE INVENTION

One aspect of the invention is the production of a low-calorie, low-fat fruit and dairy-based beverage from yogurt, preferably non-fat yogurt, water and a fruit preparation by inline static mixing of (1) yogurt, (2) water and (3) a fruit preparation which may optionally contain one or more food additives, to produce a beverage containing live and active cultures of bacteria, such as ≧10⁶ CFU/gr Lactobacillus acidolphilus, and having a viscosity ranging from 85 to 175 mPa.s and a pH ranging from 4.0 to 4.5.

Another aspect of the invention is the production of a low-calorie, low-fat fruit and dairy-based beverage by inline static mixing of (1) yogurt which has been premixed with water and (2) a fruit preparation, which may optionally contain one or more food additives, to produce a beverage containing live and active cultures of bacteria and having a viscosity ranging from 85 to 175 mPa.s and a pH ranging from 4.0 to 4.5.

The process of the present invention also encompasses the separate addition of supplementary ingredients or additives either to the primary ingredients of yogurt, water and fruit, or separately during the mixture of the primary ingredients of the fruit- and dairy based beverage.

Another aspect of the invention is the low-calorie, low-fat fruit and dairy-based beverage produced, for example, by any of the above processes having a viscosity ranging from 85 to 175 mPa.s and a pH ranging from 4.0 to 4.5.

### DETAILED DESCRIPTION OF THE INVENTION

Yogurt production may begin with the fermentation of raw and/or processed milk products. Milk products such as whole, reduced fat, skim, condensed, or dry milk may be used. Generally bovine milk is used, though yogurt may also be produced from the milk of other mammals, such as goats or sheep. Soy or nut milks can also be added to or substituted for animal milk mixtures to produce yogurt products.

One method of non-fat yogurt production proceeds by blending non-fat dry milk powder with non-fat milk and with a mixture of vitamins such as vitamins A and D. After suitable hydration of the non-fat dry milk powder occurs, usually after a period ranging from about 30 minutes to 2 hrs, the milk mixture is preheated and homogenized. The resulting mixture is then pasteurized, for example at a temperature of about 198° F. for approximately 6 to 7 minutes. The pasteurized milk mixture is then cooled to a temperature suitable for fermentation by lactose metabolizing bacteria.

The cooled milk mixture is inoculated with appropriate strains of bacteria, such as Lactobacillus bulgaricus and Streptococcus thermophilus. Other strains of lactose-fermenting bacteria may also be added, such as Lactobacillus acidophilus or Lactobacillus bifidus, to assist in the fermentation or provide probiotic properties to the final beverage.

To augment the probiotic properties of the yogurt-based beverage Lactobacillus casei may be added, for example in an amount of 10⁵, 10⁶, 10⁷, or 10⁸ c.f.u./ml. Other probiotic microorganisms which may be added in similar amounts either during or after fermentation include Lactobacillus gasseri, Lactobacillus plantarum, Lactobacillus johnsonii, Lactobacillus reuteri, Lactobacillus rhamnosus, Bifidobacterium bifidum, Bifidobacterium lactis, Bifidobacterium longum, Bifidobacterium breve, Bifidobacterium infantis, Enterococcusfaecium, Enterococcusfaecalis, and Streptococcus salivarius or the yeast Saccharomyces boulardii.

The inoculated milk culture is maintained under conditions favoring curd formation and thus allowed to ferment without substantial agitation. Generally, the fermentation temperature is kept within the range of 102±2° F. When the mixture reaches a pH ranging from about 4.4 to 4.6, usually, about 4.55, it is agitated and cooled to slow or stop the initial fermentation.

The resulting yogurt base product is then cooled to about 35 to 45 degrees F., preferably about 41° F. and filtered to remove lumps, for instance, by passage through a ⅛ inch wire mesh filter.

The yogurt base product, or white mass, may then be stored at a reduced temperature for 10-15 hours, e.g., at 41° F., until mixing with water and the fruit preparation.

The water used in the process of the present invention must be suitable for use in commercial food and beverage products, and must be compatible with the presence of live yogurt-producing bacteria. Water complying with U.S. EPA drinking water standards is generally acceptable for use in the process of the present invention. However, care must be taken to avoid water containing ingredients that would negatively impact the flavor, pH, color, texture, or the activity of the bacterial cultures in the beverages of the invention. Prior to use in the process of this invention, the water may be filtered and/or pasteurized.

The fruit preparations may be conventional fruit purees or sauces, or chopped fruit pieces. For ease of consumption, generally fruit pieces are no larger than 2 mm in diameter in the final product.

The typical fruit base is 30-50% fruit with a maximum piece size of ⅛″ to avoid a choking hazard; 30-50% water, 20-25% sugar, such as fructose or sucrose, 0-10% fruit juice (single strength), and 1-5% of a suitable stabilizer, and color (e.g. vegetable or fruit juice concentrate, such as beet or carrot juice concentrate, annatto extract or carmine, or other natural or artificial color), flavor, acid (e.g., citric or malic acid), buffer (e.g., sodium citrate) and/or preservative (e.g., potassium sorbate). Fruit juice may be added as a concentrate or at single strength and from a single type of fruit or from multiple types of fruit. Such juices include, but are not limited to, juices from fruit preparations conventionally found in yogurt products, such as berry juices, strawberries, peaches, or tropical fruits, as well as grape juice, white grape juice, apple juice, pear juice, apricot juice, pineapple juice, pomegranate juice, and passion fruit juice.

A fruit preparation may have acidity in the range of about pH 3.9 a BRIX of about 31 and a BOSTWICK at 40° F./60 sec of about 9 cm. Its density may be about 9.5 lbs/gal. The exact amounts of fruit solid contents may be determined by one with skill in the art based on the particular type of fruit, keeping in mind the characteristics of the final product, such as viscosity.

The process of the invention may further comprise mixture of conventional food additives into the dairy based beverage before or during inline mixing of the fruit and yogurt components. Additives, such as acidulants, antioxidants, bulking agents, bulking sweeteners, colorants, dietary fiber, emulsifers, enzymes, fat replacers, flavors, flavor enhancers, gases, preservatives, non-nutritive sweeteners, processing aids, stabilizers or thickeners which may be added to consumable foods and beverages are known in the art and are described by the Kirk-Othmer Encyclopedia of Chemical Technology, 4th edition, vol. 11, “Food Additives”, pages 805-833, which is incorporated by reference. For example, natural sweeteners, such as sucrose, dextrose, or fructose, or artificial sweeteners, such as aspartame, sucralose, saccharin, cyclamate, acetsufame K, alitame, glycyrrhizin, stevioside, or thaumatin may be added to the fruit preparation prior to its mixture with the yogurt or may be added during mixture of the yogurt and fruit preparation.

In a preferred process, the yogurt base product, or white mass, water and fruit preparation are separately introduced and mixed by means of an inline mixer. Alternatively, taking into account any applicable regulatory guidelines, water may first be added to the yogurt, or to the fruit preparation, and then the water-yogurt or water-fruit preparation, separately introduced and mixed in line, respectively, with the fruit preparation or the yogurt base product or white mass.

A static inline mixer is used to mix the primary components. Such static inline mixers are known in the art and any type of inline static mixer may be used so long as it results in the production of a homogeneous product with the desired viscosity and organoleptic characteristics. One may select a suitable static inline mixer from amongst those known in the art, for example, from those described by the Kirk-Othmer Encyclopedia of Chemical Technology, 4th edition, “Mixing and Blending”, vol. 16, pages 844-887, or by pages 201-204 of Yogurt Science and Technology, both of which are hereby incorporated by reference.

The massic ratio of yogurt base product or white mass: water: fruit preparation introduced into the inline static mixer ranges from 92-50%:5-25%:3-25%. Depending on the characteristics of the yogurt and the fruit preparation and any food additives, an appropriate ratio is selected to provide a final fixed fruit/diary beverage having a pH in the range of 4.0 to 4.5 and a viscosity in the range of 80 to 180 mPa.s. Viscosity may be determined using a Mettler RM180 Rheomat rotational viscometer.

The amount of water ranges from 5-25%, usually from 15-25%. This range is intended to include all intermediate subranges and values, such as 15, 16, 17, 18, 19, 20, 21, 22, 23, 24 and 25%.

The amount of fruit preparation may range from 3-25%, and includes all intermediate values and subranges, such as 5-20%, 10-15%, and 15-20%. Exemplary values include 3, 4, 5, 6, 7, 8, 9, 10, 11, 12, 13, 14, 15, 16, 17, 18, 19, 20, 21, 22, 23, 24 and 25%.

After mixing is completed the fruit-based and dairy-based beverage has a pH in the range of 4.0 to 4.5. Above a pH of 4.5, the mixture would be less resistant to the growth of undesirable microorganisms. Other suitable pH ranges include pH 4.05 to 4.45, pH 4.1-4.4, and pH 4.2-4.3. However, any subrange or intermediate value in the above pH ranges is contemplated. Exemplary pH values are 4.05, 4.1, 4.25, 4.35, or 4.45.

The fruit-based dairy-based beverage produced by the process of the invention has viscosity in the range of 80 to 180 mPa.s. Other suitable viscosity ranges include 90 to 170 mPa.s, 100 to 150 mPa.s, 110 to 140 mPa.s, and 120 to 130 mPa.s. Exemplary viscosities are 80, 85, 90, 95, 100, 110, 115, 120, 125, 130, 135, 140, 150, 160, 165, 170, 180 and include any intermediate value or subrange of the ranges indicated above.

The resulting beverage mixture may then be filled into containers and the containers palleted for distribution. The palletized product is shipped under refrigerated conditions.

### EXAMPLE

Non-fat milk and dry non-fat milk powder and Vitamin A & D premix is mixed and allowed to hydrate for about 30 mins. This mixture is heated to about 140° F. and homogenized. The homogenized milk mixture is heated to approximately 198° F. and held for about 6.5 mins to kill pathogenic microorganisms.

Subsequently the mixture is cooled to a temperature of about 102° F. and inoculated with about 0.01% of a mixture of Lactobacillus bulgaricus and Streptococcus thermophilus, as well as about 0.0012% Lactobacillus acidophilus. The mixture is held with minimal agitation at 102° F. until curd formation occurs and a break pH of about 4.60 is reached. To inhibit further reduction in pH and bacterial growth, the mixture (yogurt or white mass) is agitated and cooled to about 41° F., filtered through a ⅛ inch wire mesh to remove lumps, and the filtered white mass or yogurt is held up to 15 hours at this temperature.

The cooled yogurt, water and fruit preparation in a massic ratio of approximately 65:25:10 is pumped in line static mixer (Admixer™) to produce a fruit beverage composition having a pH of about 4.25 and a viscosity of about 120 mPa.s. The filled containers are shipped and refrigerated at a temperature of about 41° F. prior to sale.

### Modifications and Other Embodiments

Various modifications and variations of the disclosed processes and products and as well as the concept of the invention will be apparent to those skilled in the art without departing from the scope and spirit of the invention. Although the invention has been described in connection with specific preferred embodiments, it should be understood that the invention as claimed is not intended to be limited to such specific embodiments. Various modifications of the described modes for carrying out the invention which are obvious to those skilled in the food sciences, nutritional, microbiological, chemical or related fields are intended to be within the scope of the following claims.

### INCORPORATION BY REFERENCE

Each document, patent, patent application or patent publication cited by or referred to in this disclosure is incorporated by reference in its entirety.

1. A process for producing a low-calorie or low-fat dairy beverage comprising:
inline static mixing of yogurt with an amount of water and an amount of a fruit preparation sufficient to form a beverage having:
a viscosity ranging from 85 to 175 mPa.s and
a pH ranging from 4.0 to 4.5.

2. The process of claim 1, wherein said yogurt is non-fat yogurt.

3. The process of claim 1, wherein said yogurt is fermented from a mixture of non-fat milk, non-fat milk solids and Vitamins A and D.

4. The process of claim 1, wherein said yogurt is produced from whole or low-fat milk.

5. The process of claim 1, wherein said yogurt contains Lactobacillus acidophilus or Lactobacillus bifidus, or both.

6. The process of claim 1, wherein said fruit preparation is a fruit sauce.

7. The process of claim 1, where said fruit preparation is a fruit puree.

8. The process of claim 1, wherein said fruit preparation comprises pieces of fruit up to 2 mm in diameter.

9. The process of claim 1, wherein the water and yogurt are first mixed with each other prior to mixing with the fruit preparation.

10. The process of claim 1, wherein the water and fruit preparation are first mixed with each other prior to mixing with the yogurt.

11. The process of claim 1, wherein the water and fruit preparation are separately mixed into or pumped into the yogurt.

12. The process of claim 1, further comprising adding to said beverage one or more sweeteners selected from the group consisting of sucrose, fructose, and dextrose.

13. The process of claim 1, further comprising adding to said beverage one or more sweeteners selected from the group consisting of aspartame, sucralose, saccharin, cyclamate, acetsufame K, alitame, glycyrrhizin, stevioside, and thaumatin.

14. The process of claim 1, further comprising adding to said beverage one or more food additive(s).

15. The process of claim 1, further comprising adding to said beverage one or more flavoring(s).

16. The process of claim 1, further comprising adding to said beverage one or more vitamin(s) or mineral(s).

17. The process of claim 1, further comprising adding to said beverage one or more food color(s).

18. The process of claim 1, wherein said viscosity ranges from 90 to 150 mPa.s.

19. The process of claim 1, wherein said viscosity ranges from 100 to 120 mPa.s.

20. The process of claim 1, wherein said pH ranges from 4.1 to 4.4.

21. The process of claim 1, wherein said pH ranges from 4.2 to 4.3.

22. The process of claim 1, wherein said beverage has a total solids content in the range of about 5 to 15% by weight.

23. The process of claim 1, wherein said beverage has a protein content in the range of 0.5% to 5% by weight.

24. The process of claim 1, wherein said beverage has a fruit content ranging from 3% to 10% by weight.

25. A low-calorie or low-fat dairy beverage produced by the process of claim 1.
